(19) United States
(12) Patent Application Publication
(10) Pub. No.: US 2013/0168124 A1
(43) Pub. Date: Jul. 4, 2013

(54) Busway for High Voltage, High Current Applications

(71) Applicant: Edward Herbert, Canton, CT (US)

(72) Inventor: Edward Herbert, Canton, CT (US)

(21) Appl. No.: 13/615,505

(22) Filed: Sep. 13, 2012

Related U.S. Application Data
(60) Provisional application No. 61/534,308, filed on Sep. 13, 2011.

(51) Int. Cl. H01B 7/08

(52) U.S. Cl. CPC H01B 7/0807
USPC 174/68.1

(57) ABSTRACT

A busway for high voltage, high current applications in which connections can be made at arbitrary distance and spacing along its length is made with an insert that is a continuous semi-rigid insulator with continuous conductors installed in it. The busway is fabricated with an insert that is a long flat insulating strip with conductors installed in it, up to hundreds of feet if desired, and rolled up for shipment and handling. When installed, shell segments are installed end-to-end, then the insert is unrolled, folded into an inverted “U” shape, then installed in the shell segments as a continuous insulator and conductor. The inverted “U” shape tends to repel moisture that may enter from the top, and no segment-to-segment connectors are needed.

### CROSS REFERENCE TO RELATED APPLICATIONS

This patent application is a continuation in part of a provisional patent application Ser. No. 61/534,308 of the same name filed Sep. 13, 2011. Priority is claimed to its filing date, and this patent application is incorporated herein by reference.

### BACKGROUND OF THE INVENTION

This application relates to electrical busways, and in particular to busways for high voltage and high current in which connections can be made at arbitrary distance and spacing along its length. Prior art busways are made in preassembled sections of 10 to 20 feet in length, installed separately end-to-end and connected with separate connectors.

This application refers to U.S. patent application Ser. No. 13/170,024 filed Jun. 27, 2011 entitled Arc-flash Detection Using Di/dt, and this patent application is incorporated herein by reference.

This application refers to U.S. patent application Ser. No. 13/184,478 filed Jul. 15, 2011 entitled Method and Apparatus for Reducing Shock and Arc-flash Hazards in Power Distribution Systems, and this patent application is incorporated herein by reference.

This application refers to U.S. patent application Ser. No. 13/015,470 filed Jan. 27, 2011 entitled Power Distribution System for Data Centers and Like Application, and this patent application is incorporated herein by reference.

This application refers to U.S. provisional patent application Ser. No. 61/242,024 filed Sep. 14, 2009 entitled Arc-Flash Prevention in High Voltage Power Distribution Systems, and this patent application is incorporated herein by reference.

This application refers to U.S. provisional patent application Ser. No. 61/252,972 Oct. 19, 2009 entitled Arc-Flash Prevention in Higher Voltage Power Distribution Systems, and this patent application is incorporated herein by reference.

This application refers to U.S. provisional patent application Ser. No. 61/298,691 filed Jan. 27, 2010 Arc-flash Prevention in 480/270 V Ac and 400 V Dc Power Delivery Systems for Data Centers, and this patent application is incorporated herein by reference.

This application refers to U.S. provisional patent application Ser. No. 61/359,558 filed Jun. 29, 2010 entitled Arc-flash Detection, and this patent application is incorporated herein by reference.

This application refers to U.S. provisional patent application Ser. No. 61/364,48 Jan. 15, 2010 Method and Apparatus for Reducing Shock and Arc-flash Hazards in Power Distribution Systems, and this patent application is incorporated herein by reference.

### SUMMARY OF THE INVENTION

This patent application teaches a busway that can be fabricated with an insert that is a long flat insulating strip with conductors installed in it, up to hundreds of feet if desired, and rolled up for shipment and handling. When installed, shell segments are installed end-to-end, then the insert is unrolled, folded into an inverted “U” shape, then installed in the shell segments as a continuous insulator and conductor. The inverted “U” shape tends to repel moisture that may enter from the top, and no segment-to-segment connectors are needed.

### BRIEF DESCRIPTION OF THE FIGURES

FIG. 1 shows a representative insulator for the insert for the busway.

FIG. 2 shows a section of a pair of representative conductors for the busway.

FIG. 3 shows a cross-section with more detail of the conductor.

FIG. 4 shows a side view of a small piece of the conductor.

FIG. 5 shows possible assembly steps for making a representative insert.

FIG. 6 shows a section of a representative insert, still flat so that it can be rolled up.

FIG. 7 shows a representative shell for a busway.

FIG. 8 shows the insert, folded, being inserted into the shell.

FIG. 9 shows the busway with the insert installed in the shell.

### DETAILED DESCRIPTION

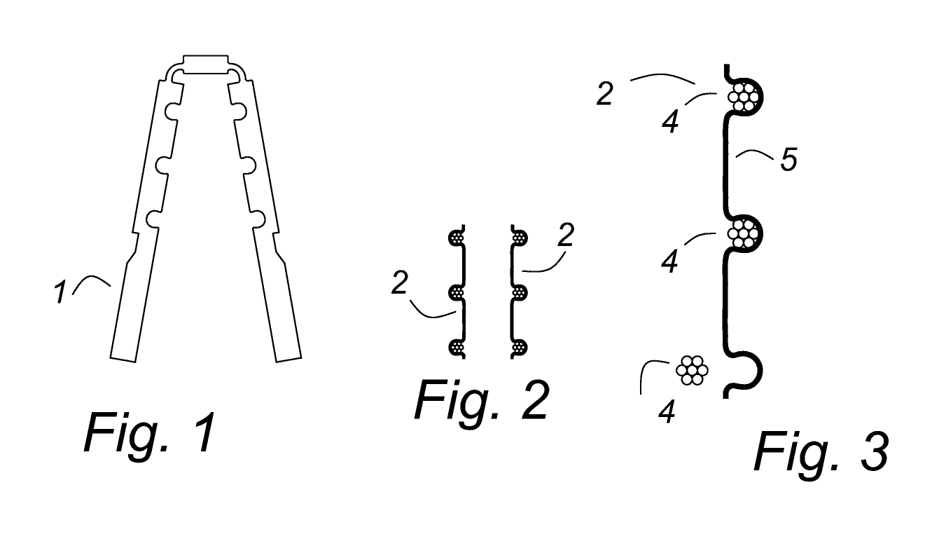

FIG. 1 shows a representative insert 1 for a busway. It is contemplated that the insert 1 will be made of a semi-rigid insulating material, sufficiently rigid to hold its shape, but flexible enough so that it can be folded where the section is reduced.

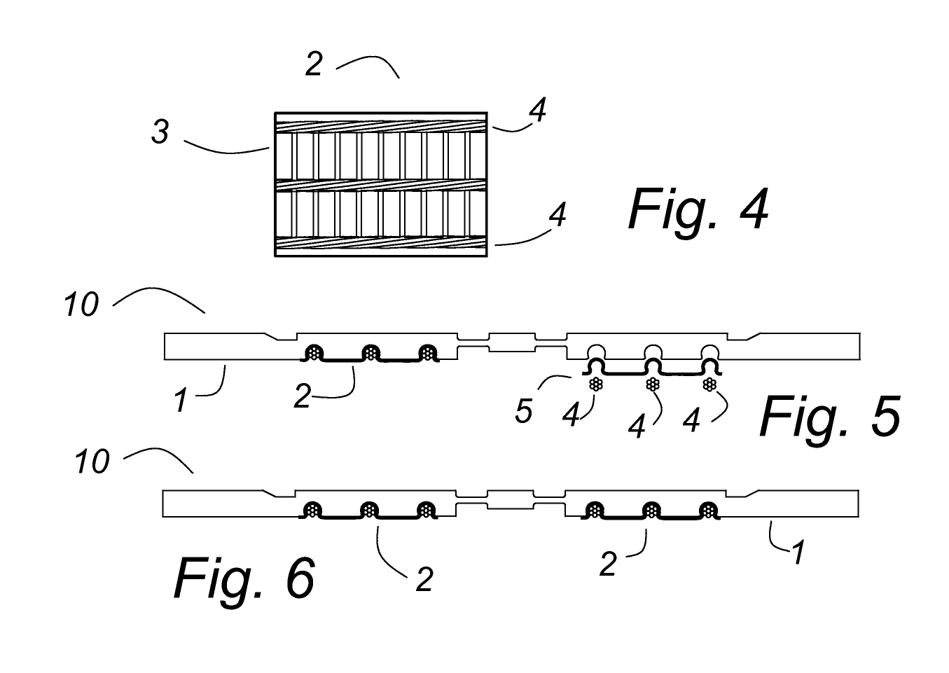

FIG. 2 shows a representative pair of conductors 2, 2 in section. FIG. 3 shows that the conductors 2 comprise continuous conductors 4-4 with bridging members 5. This can be seen as well in FIG. 4, which shows a side view of a short segment of the conductor 2. It is contemplated that the conductor will be made in long lengths, perhaps hundreds of feet. Many designs are possible, but this design has an advantage in that the conductors 4-4 can be usual wiring cable.

FIG. 5 shows a representative insert 5, still flat so that it can be rolled up, comprising the insulator 1 and conductors 2. The conductors 2 can be pre-assembled, as shown in FIGS. 2 through 4, or it could be assembled as it is being inserted into the insulator 1.

FIG. 6 shows the insert 10 fully assembled and still flat so that it can be rolled up. It is contemplated that it can be made in long lengths, perhaps hundreds of feet.

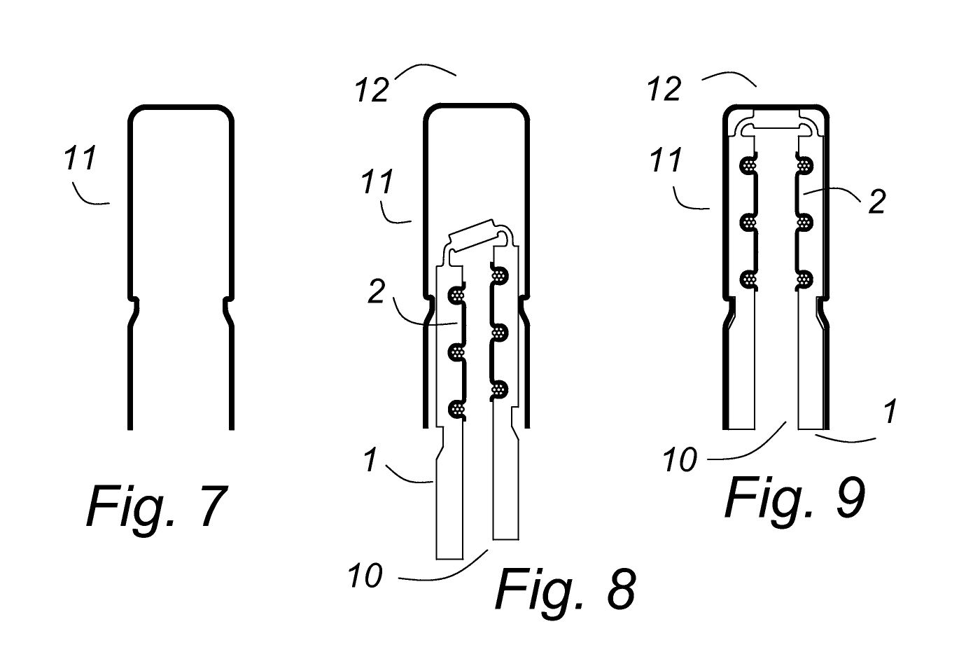

FIG. 7 shows a section of a representative shell 11. It is contemplated that the shell 11 will be made in shorter sections, perhaps 10 to 20 feet, as an example, not a limitation, and that the short sections will be installed end-to-end where the busway is desired. There may be many sections extending a long distance, perhaps hundreds of feet. It is also contemplated that additional sections will be installed beside each other to accommodate additional conductors. Two are needed for a power source and its return, three are needed for three-phase ac, and there may be more, for neutral or ground, as examples, not limitations.

FIG. 8 shows the insert 10 folded and partly inserted into the shell 11 to make a busway 12. FIG. 9 shows the busway with the insert 10 fully installed in the shell 11.

1. A busway for high voltage, high current applications comprising
an insert comprising
a long flat insulator of semi-rigid insulating material,
at least two long conductors installed into the long flat insulator,
the insert being flat can be rolled up for handling and for shipment,
the busway further comprising a plurality of shells that may be installed end-to-end to make a continuous conduit for receiving the insert,
the insert further being folded into an inverted “U” shape so that it can be inserted into the plurality of shells as a continuous insulator with conductors therein.
